(19) United States
(12) Patent Application Publication
(10) Pub. No.: US 2003/0055965 A1
(43) Pub. Date: Mar. 20, 2003

(54) User-defined units of context in a distributed computer environment

(75) Inventors: Mercer Logan Colby, Rochester, MN (US); Alexandra Mulholland, Winchester (GB); Ian Robinson, Southhampton (GB)

Correspondence Address: Gero G. McClellan, Thomason, Moser & Patterson, L.L.P., 3040 Post Oak Boulevard, Suite 1500, Houston, TX, 77056-6582, US

(73) Assignee: International Business Machines Corporation, Armonk, NY

(21) Appl. No.: 09/956,718

(22) Filed: Sep. 20, 2001

(51) Int. Cl. G06F 15/173; G06F 15/16

(52) U.S. Cl. 709/225; 709/203

(57) ABSTRACT

A method and apparatus for creating user-definable context that is associated with every request made by a client in a distributed computer environment. A work-area is created to contain the user-defined context. The work-area is then associated with the thread of the client request. A server retrieves the context and processes the client request according to the context.

### BACKGROUND OF THE INVENTION

1. Field of the Invention

The present invention relates to a distributed computer enterprise and more particularly to a system and method for implicitly sending end user-definable context with a remote request.

2. Description of the Related Art

Generally, a distributed computer system comprises a collection of loosely coupled machines (mainframe, workstations or personal computers) interconnected by a communication network. Through a distributed computer system, a client may access various servers to store information, print documents, access databases, acquire client/server computing or gain access to the Internet. These services often require software applications running on the client's desktop to interact with other applications that might reside on one or more remote server machines. Thus, in a client/server computing environment, one or more clients and one or more servers, along with the operating system and various inter-process communication (IPC) methods or mechanisms, form a composite that permits distributed computation, analysis and presentation.

In client/server applications, a “server” is typically a software application routine or thread that is started on a computer that, in turn, operates continuously, waiting to connect and service the requests from various clients. Thus, servers are broadly defined as computers, and/or application programs executing thereon, that provide various functional operations and data upon request. Clients are broadly defined to include computers and/or processes that issue requests for services from the server. Thus, while clients and servers may be distributed in various computers across a network, they may also reside in a single computer, with individual software applications providing client and/or server functions. Once a client has established a connection with the server, the client and server communicate using commonly-known (e.g., TCP/IP) or proprietary protocol defined and documented by the server vender.

One of the foundations of distributed computing is the ability to pass information, typically in the form of arguments to remote methods, from one process to another. Conventionally, when application level software is written over middleware services, many of the services rely on information beyond that passed in the application's remote calls. Such services often make use of the implicit propagation of information, or context, used for processing remote requests in addition to the arguments passed in remote requests. In a distributed computer environment there are a number of pieces of context that are implicitly flowed on remote requests. For example, transactional contexts, security contexts, tracing contexts and locale contexts are implicitly associated with a remote call and transmitted with the request. These contexts are typically associated with a remote request without the user's knowledge, intervention or control.

Since a user has no control of the context associated with a client request, conventional distributed applications are often incapable of representing a specific client's environment on a server. As soon as a request leaves the client process, the server no longer has access to the properties that define the imported client process. There is currently no mechanism for a user to define context representing application specific properties of the client request (such as locale, security tokens, a distributed thread ID, a user's priority, for example) that will then implicitly propagate on all remote requests and be made available to all servers processing the request.

Therefore, there is a need for a method and apparatus that allows users to explicitly define arbitrary properties that will implicitly propagate on all remote client requests and be made available to all servers servicing the request.

### SUMMARY OF THE INVENTION

The present invention generally provides an apparatus, a program product, and a method for associating end user-defined context with a request in a distributed computer environment.

In one embodiment, a method is provided to initialize a work-area interface with a user's application. Once the work-area interface is initialized, a work-area is created and configured to contain the end-user defined context. The work-area is then associated with a request and sent with the request to at least one remote machine in the distributed computer environment.

In another embodiment, a method is provided to receive a remotely defined work-area from a computer in the distributed computer environment. The context from the remotely defined work-area is then retrieved and used to process the remote request.

In still another embodiment, a method is provided to create a work-area that is nested into an already defined work-area. Context inserted into the nested work-area masks corresponding information contained in the already defined work-area.

In another embodiment, the foregoing methods are implemented as programs stored on a computer readable medium. In still another embodiment, the foregoing methods are implemented in computer systems in distributed environments.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a network environment comprising a server and a client.

FIG. 2 is a block diagram of an illustrative client computer system.

FIG. 3 is a block diagram of an illustrative server computer system.

FIG. 4 shows properties in nested work-areas.

FIG. 5 shows existing properties in a work-area masked by a nested work-area.

FIG. 6 illustrates work-area propagation over a distributed computer environment.

FIG. 7 illustrates a flow chart of the method.

### DETAILED DESCRIPTION OF THE PREFERRED EMBODIMENTS

Methods and apparatus provide a work-area comprising nested work-areas that contain end user-definable context information. A work-area defines a particular unit of context which is a programmatically demarcated unit of work during which context associated with the work-area is available throughout the distributed system on a given distributed thread of execution. Work-areas may contain nested work-areas. A work-area may represent the accumulated context of multiple nested work-areas that are all active on a particular thread at a particular point in execution. The work-area context will implicitly propagate on all remote requests made by a client in a distributed computer environment. Implicit propagation means that the work area context is automatically associated with every remote request. Illustratively, work-area context may be automatically sent along with a remote request using any programming implementation. For example, a CORBA (Common Object Request Broker Architecture) implementation may use an OMG-specified interceptor; other protocols like SOAP (W3C's Simple Object Access Protocol) or a messaging service like IBM's MQSeries may use another relevant context handler. Likewise, an appropriate context handler or interceptor will remove the work-area context from the remote request and associate it with the current server-side thread of execution in order that the data will be made available transparently to the end consumer of the context. Illustratively, a server may be a client to yet another server. In that instance, the context will continue to flow transparently including additions or modifications to the work-area context (including the addition of nested scopes of context).

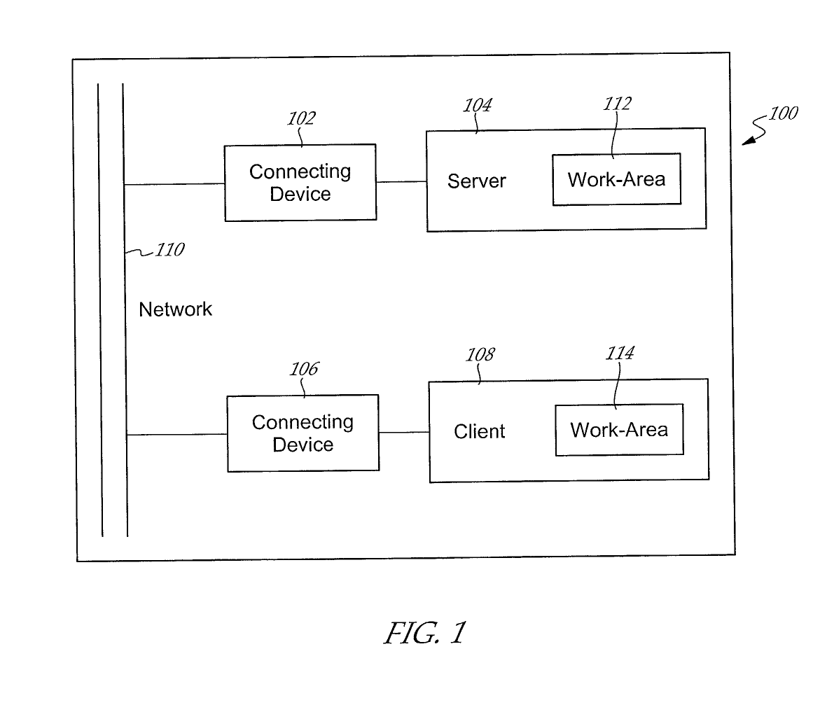

One embodiment of the invention is implemented as a program product for use with a computer system such as, for example, the network environment 100 shown in FIG. 1 and described below. The program(s) of the program product defines functions of the embodiments and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program” or “application program interface” (API). The computer program typically is comprised of a multitude of instructions that will be translated by the native computer into a machine-readable format and hence executable instructions. Alternatively, the computer program is in an executable form. Also, programs are comprised of variables and data structures that either reside locally to the program or are found in memory or on storage devices, the storage devices being either local or remote. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 illustrates a block diagram of a client 108 and server 104 computer network in accordance with the method and system of the embodiments. In one embodiment, client computer system 108 connects to a network 110 by means of a connecting device 106. Also connected to the network are one or more server computers 104 connected by means of their own connecting device 102. Those skilled in the art will appreciate that these connecting devices may take various forms, including modems, token-ring hubs, Ethernet hubs, routers and other network enabling devices. Further, the network 110 may be any network configuration including a Local Area Network (LAN), a Wide Area Network (WAN), or any combination of various coupled networks. In a particular embodiment, the network 110 includes the Internet. Communication between the client 102 and server 104 may be facilitated by any known or unknown protocols. One popular protocol which may be used to advantage is Transmission Control Protocol/Internet Protocol (TCP/IP).

The server 104 includes an area of system memory and/or disk storage space dedicated to storing and maintaining a work-area 112. The client 108 includes an area of system memory and/or disk storage space dedicated to storing and maintaining a work-area 114. Although only one client computer 108 and one server computer 104 is shown, any number of client and server computers may be connected to the network 110.

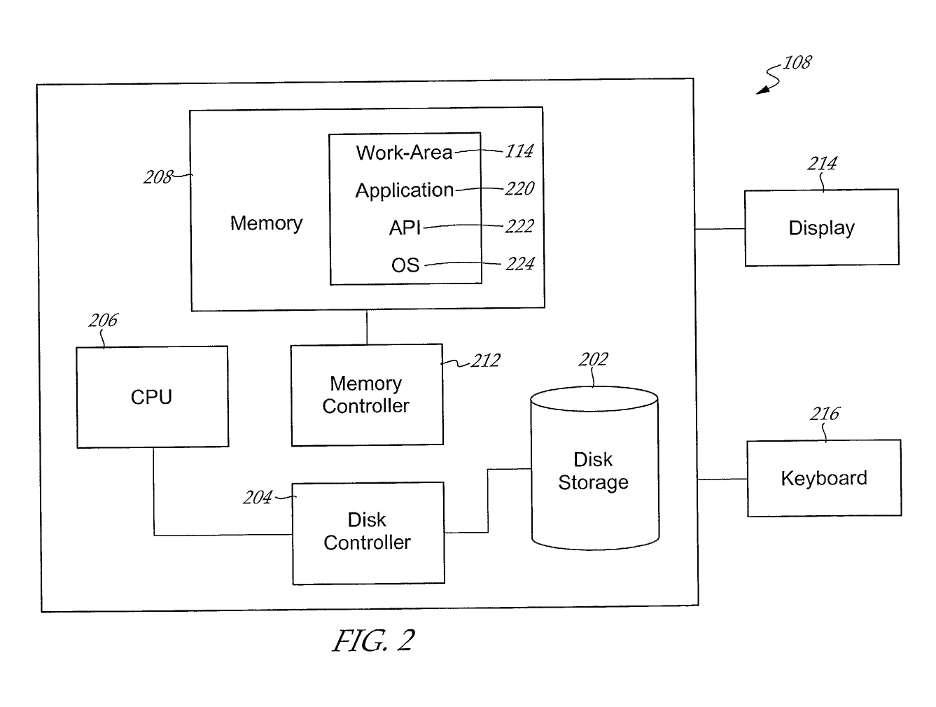

FIG. 2 shows an illustrative embodiment of the client computer system 108. In one embodiment, the client computer system 108 includes a central processing unit (CPU) 206, a memory controller 212, system memory 208, disk storage 202, and a disk storage controller 204. Illustratively, the system 108 includes a display 214,a keyboard 216 and an interface port 218. Illustratively, the interface port 218 may be a serial or parallel communications port that allows the client 108 to be connected to a network connecting device 106. The system memory 208 comprises a work-area 114 for storing user-definable context(s) that implicitly flows with a request, an application 220, a work-area application program interface (API) 222 for interfacing the work-area 114 to the application 220, and an operating system 224.

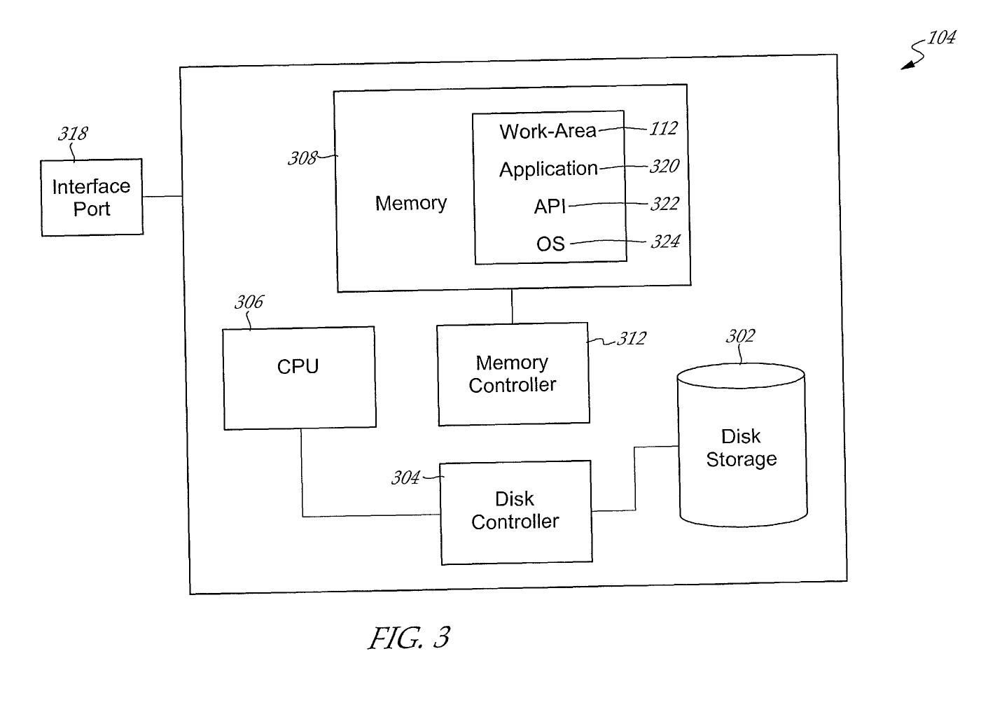

FIG. 3 shows an illustrative embodiment of the server computer system 104. In one embodiment, the server computer system 104 includes a central processing unit (CPU) 306, a memory controller 312, system memory 308, disk storage 302, a disk storage controller 304, and an interface port 318. Illustratively, the interface port 318 may be a serial or parallel communications port that allows the server 104 to be connected to a network connecting device 102. The system memory 308 comprises a work-area 112 for retrieving user-definable context(s) that implicitly flows with a client request and for storing user-definable context(s) that implicitly flows with a server request, an application 320, a work-area application program interface (API) 322 for interfacing the work-area 112 to the application 320, and an operating system 324.

In one embodiment, the client 102 and/or the server 104 are configured with WebSphere. WebSphere is a software product available from International Business Machines, Inc. In such an embodiment, the work area facilities described herein may be integral to the WebSphere utility.

### 1.0 Overview

The work-area facility allows an application to generate a work-area, insert information into the work-area, and then make remote invocations. The work-area is propagated with each remote method invocation, eliminating the need to explicitly include an appropriate argument in the definition of every method. The methods on the server side may use or ignore the information propagated in the work area. If methods in a server receive a work-area from a client and subsequently invokes other remote methods, the work-area is propagated with the server's remote requests. When the creating application is done with the work-area, the work-area is terminated.

This life-cycle of the work-area (from client to server(s) and then back to the client) is called the “scope” of the work-area. The scope of the work-area as defined above is therefore insensitive to process boundaries of a server since the work-area will propagate from the client to a server and then to other servers.

There are two prime considerations in deciding whether to pass information explicitly as an argument or implicitly by using a work-area. The first consideration is pervasiveness, or is the information used in a majority of the methods in an application. The second consideration is size, or is it reasonable to send the information even when it will not be used.

When information is sufficiently pervasive, it is easier and more efficient to make it available everywhere. Applications may be written to make use of the work area facility to simplify programming and maintenance of the code to enable the connection of otherwise incompatible applications.

### 2.0 Structure of Work-Areas

As an illustration, the information in a work-area generally consists of a set of properties, or context, and a property consists of a key-value-mode triple. The key-value pair represents the information contained in the property and the key is a name by which the associated value is retrieved. The mode determines whether the property can be removed or modified. The foregoing will be discussed in greater detail below.

### 2.1 Property Modes

To change information in a property, applications may rewrite the information in the property. This has the same effect as updating the information in the property. The changes that can be made to a property is governed by the mode of the property. The mode is determined when the property is inserted into a work-area. In one embodiment, there are four possible mode values for properties: normal, read only, fixed normal, and fixed read only. An illustrative code representation of these modes is shown in Table 1. The modes are discussed in greater detail below:

TABLE 1

| | |
|---|---|
| 001 | enum PropertyModeType { |
| 002 | normal, |
| 003 | read_only, |
| 004 | fixed_normal, |
| 005 | fixed_readonly |
| 006 | }; |

Illustratively, a property's mode may determine three attributes. The first being whether the value associated with the key can be modified. Secondly, whether the property can be deleted. Thirdly, whether the mode associated with the key-value pair can be modified. The two read-only modes forbid changes to the information in the property; the two fixed modes forbid deletion of the property. The default mode is normal, allowing modification or deletion of the property.

### 2.2 Modifying Key-Value Pairs

Each of the four modes described above place restrictions on modifying the value of the key-value pair and deleting the property. In general, there are two kinds of changes governed by the modes; modifications to the property and deletion of the property from the originating work-area. Modifications to the property are made either by changing the property in the origination work-area or masking the property in a nested work-area (discussed further below).

As indicated with reference to Table 1, the four modes and their characteristics are normal, read-only, fixed normal and fixed read-only. The “normal” mode is the default mode and in this mode the value of the key can be modified and, if the key is present, it can take any value. The normal property can be deleted. For the Read-only mode, the value of the key cannot be modified and, if the key is present, the associated value must be the originally set value. The read-only property can be deleted. For the fixed normal mode the key must be present, but the value of the key can be modified. The property cannot be deleted. For the fixed read-only mode the key must be present, and the value of the key cannot be modified. The fixed read-only property cannot be deleted.

### 2.3 Changing Modes

The mode associated with a property can be changed only according to the restrictions of the original mode. The read-only and fixed read-only properties do not permit modification of the value or the mode. The fixed normal and fixed read-only modes do not allow the property to be deleted. This set of restrictions leads to the following permissible ways to change the mode of a property within the lifetime of a work-area. If the current mode is normal, it can be changed to any of the other three modes: fixed normal, read-only, fixed read-only. If the current mode is fixed normal, it can be changed only to fixed read-only. If the current mode is read-only, it can be changed only by deleting the property and re-creating it with the desired mode. If the current mode is fixed read-only, it cannot be changed. If the current mode is not normal, it cannot be changed to normal.

In any case, the key, value, and mode of any property can be effectively changed by terminating the work-area in which the property was created and creating a new work-area. Applications can then insert new properties into the work-area.

### 3.0 Nested Work-Areas

In one embodiment, applications can nest work-areas. When an application creates a work-area, a work-area context is associated with the creating thread. If the application thread creates another work-area, the new work-area is nested within the existing work-area and becomes the current work-area. Nested work-areas allow applications to define and scope properties for specific tasks without having to make them available to all parts of the application. All properties defined in the original, enclosing work-area are visible to the nested work-area. The application can set additional properties within the nested work-area that are not part of the enclosing work-area.

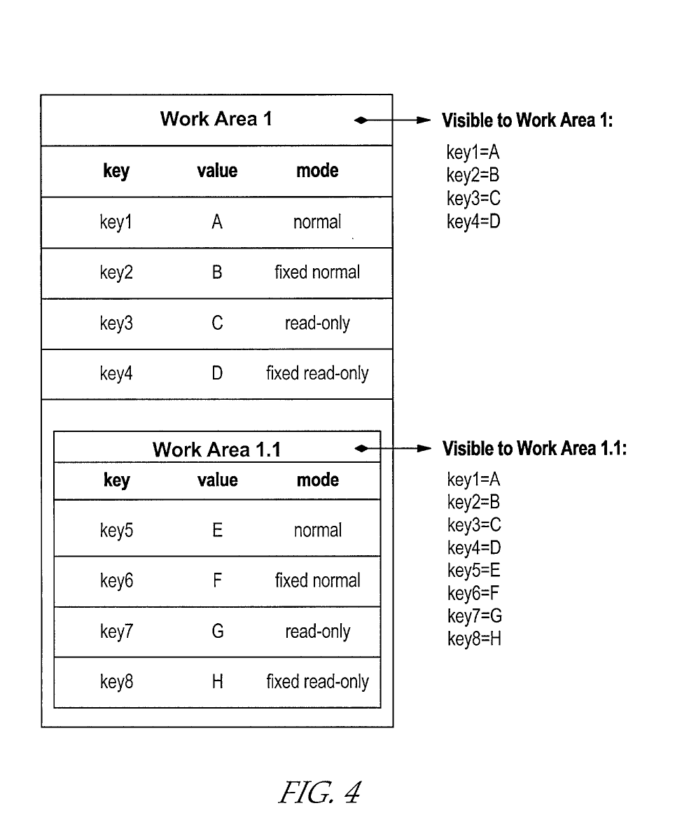

An application working with a nested work-area does not actually see the nesting of enclosing work-areas. The current work-area appears as a “flat” set of properties that includes those from enclosing work-areas. Illustrated in FIG. 4, the enclosing work-area holds several properties and the nested work-area holds additional properties. From the outermost work-area (Work Area 1), the properties set in the nested work-area (Work Area 1.1) are not visible to the application. From the nested work-area (Work Area 1.1), the properties in both work-areas are visible to the application.

Nesting can also affect the apparent settings of the properties. Properties can be deleted from or directly modified only within the work-areas in which they were set, but nested work-areas can also be used to temporarily override information in the property without having to modify the property. Specifically, depending on the modes associated with the properties in the enclosing work-area, the modes and the values of keys in the enclosing work-area can be overridden within the nested work-area.

The mode associated with a property when it is created determines whether nested work-areas can override the property. From the perspective of a nested work-area, the property modes used in enclosing work-areas either permit or do not permit a nested work-area to override the mode or the value of a key locally. The modes that permit overriding are normal and fixed normal. The modes that do not permit over-ridding are read-only and fixed read-only.

As an illustration, if an enclosing work-area defines a property with one of the overridable modes, a nested work-area can specify a new value for the key or a new mode for the property. The new value or mode becomes the value or mode seen by subsequently nested work-areas. Changes to the mode are governed by the restrictions previously described in “Changing modes”. If an enclosing work-area defines a property with one of the modes that cannot be overridden, no nested work-area can specify a new value for the key.

Changes made to a nested work area will not affect the values set into an overriding work area. Illustratively, a property identified as “A” is set into overriding work area “X”. A work area “Y” with a property identified as “B” is created and nested into overriding work area “X”. If property “A” is masked while the nested work area “Y” is current, property “A” will be restored when nested work area “Y” is completed. Nested property “B” is then discarded.

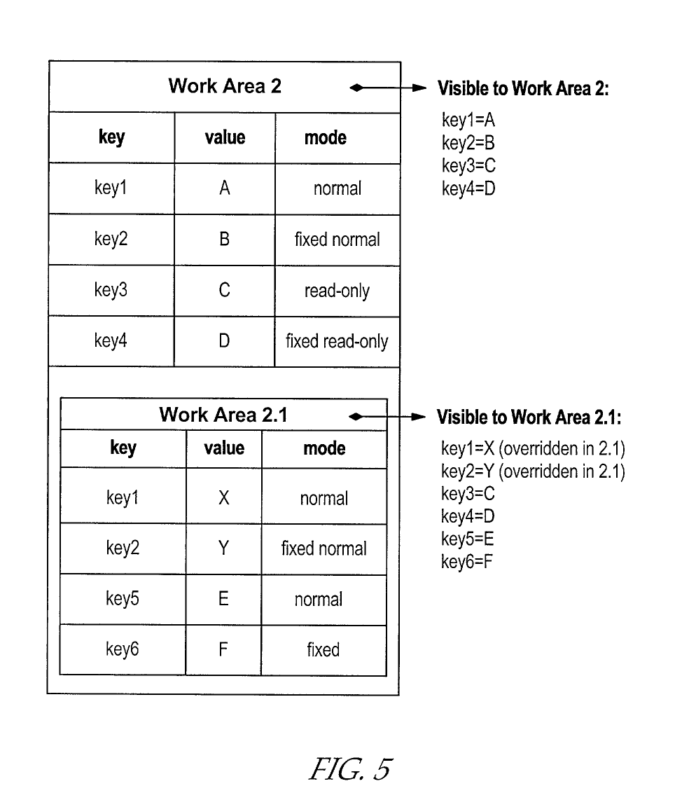

FIG. 5 illustrates the overriding of properties, discussed above, from an enclosing work-area. As illustrated, the nested Work Area 2.1 redefines two of the properties set in the enclosing Work Area 2. The other two cannot be overridden. The nested work-area also defines two new properties. From the outermost work-area (Work Area 2), the properties set or redefined in the nested work (Work Area 2.1) are not visible. From the nested work-area (Work Area 2.1), the properties in both work-areas are visible, but the values seen for the redefined properties are those set in the nested work-area.

### 4.0 Distributed Work-Areas

If a remote invocation is issued from a thread associated with a work-area, a copy of the work-area context is automatically propagated to the target object, which can use or ignore the information in the work-area as necessary. If the calling application has a nested work-area associated with it, a copy of the nested work-area context and all its ancestors is propagated to the target. The target application can locally modify the information, as allowed by the property modes, by creating additional nested work-areas. This information will be propagated to any remote objects it invokes. However, no changes made to a nested work-area on a target object are propagated back to the calling object. Depending upon the embodiment, the caller's work area may or may not be unaffected by changes made to the imported work area made in the remote method.

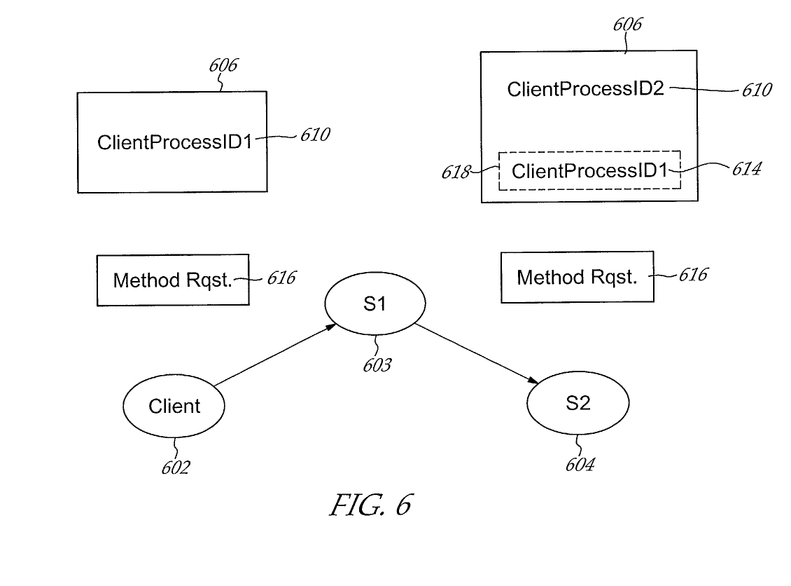

FIG. 6 illustrates the propagation of a method request with its associated work area from a client to a first and second server. In this example, the client 602 inserts ClientProcessID1 610 context into the work area 606. When the client invokes server S1 603 with the method request 616, server S1 603 can make appropriate runtime decisions based upon the imported ClientProcessID1 610. If server S1 603 requires further processing of method request 616, server S1 603 may invoke another server. In this example, server S1 603 invokes server S2 604 for further processing of the method request 616. Server S2 603 could choose to leave the ClientProcessID1 610 unchanged in order to allow Server S2 604 to continue processing with the client 602 as the identified client process. However, Server S1 603 desires that server S2 604 process the request using the identify of the server S1 603 as the client. To accomplish this, server S1 603 creates a nested work area 618 within the client 602 work area 606. Server S1 603 then inserts ClientProcessID2 614, the identity of server S1 603, into the nested work area 618. Since context contained in the nested work area 618 overrides context contained in the enclosing work area 606, context CLientProcessID2 614 will override context ClientProcessID1 610. Server S2 604 will process the request using ClientProcessID2 614 context. Server S1 603 will then complete its response to client 602 using the identity of the client, ClientProcessID1 610.

### 5.0 Example Application

In one embodiment, the work-area service may be implemented as a CORBA (common object request broker architecture) service. The function of the work area service is fully implemented on both the client and server side of the distributed system. As a request is prepared by the client ORB (object request broker), the request will have any work area context associated with the thread making the remote invocation marshalled into the request. When the request is received by the server, the server ORB will reestablish the context packed into the request as work area context on the server's thread of execution. In another embodiment, the work-area service may be implemented as a J2EE (Java 2 Enterprise Edition ) service. The embodiment may reserve certain functions (suspend, resume, export, import, begin and complete) to be invoked by J2EE-defined containers in response to parameters (container policies) configured by users; the remaining methods (get, set, remove, possibly begin and complete) to be invoked by the users of the system. The exact signature of the methods may change according to the runtime environment and programming model. As an illustration, setany(in string key, in any value) as written in IDL for a CORBA environment may be expressed as set(String key, Serializable value) in Java in the J2EE environment.

Table 2 illustrates a CORBA environment's use of the work-area. In this example, the client creates a work-area and inserts a site-identifier property into the work-area. The property may consist of a key SiteID (site identifier) and an integer value. The integer is one of an enumerated type called Location (line 001), defined in the CORBA IDL fragment shown in Table 2.

TABLE 2

| | |
|---|---|
| 001 | enum Location { |
| 002 | Main, |
| 003 | NewYork_Sales, |
| 004 | NewYork_Development, |
| 005 | London_Sales, |
| 006 | London_Development |
| 007 | } |

In this example, the client makes an invocation on a remote object. The work-area is then automatically propagated with the invocation. None of the methods on the remote object take a work-area argument. On the remote side, each method checks the work-area to determine whether a site identifier is present. If so, the method extracts the site identifier and uses the value to guide its work. For example, a site identifier from a client can be used by a server in a simple identification system, or it can be used to determine how to construct return values for the remote method invocation.

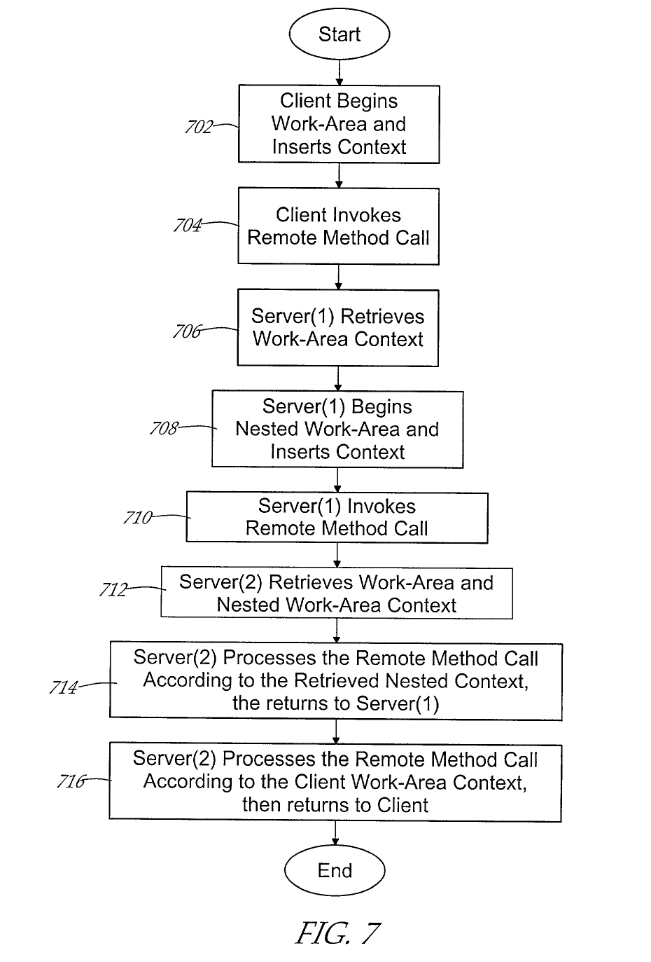

Referring first to FIG. 7, a method 700 is shown illustrating the operation of the work-area. The method 700 is entered at step 702. At step 702, the client begins a work-area and then inserts context into the work-area. At step 704, the client invokes a remote method call that has the client work-area associated with the call. At step 706, server(1) retrieves the client work-area context from the client remote method call and begins a nested work-area at step 708. The nested work-area nests within the client work-area. Server(1) inserts context into the nested work-area and then invokes a remote method call at step 710. The client work-area along with the server(1) created nested work-area is associated with the call.

At step 712, server(2) retrieves the client work-area context and the server(1) nested work-area context. At step 714, server(2) processes the remote method call according to the retrieved server(1) nested work-area context and client work-area context, and returns the results to server(1). Server(1) then processes the remote method call according to the client work-area context and returns the results to the client at step 716.

### 6.0 Work-Areas in the CORBA Environment

The following code listing in Table 3 illustrates a CORBA interface to the work-area and defined below:

TABLE 3
001 interface Current CORBA::Current
002 void begin(in string name);
003 void complete( ) raises(NoWorkArea, NotOriginator);
004 string getName( );
005 StringArray retrieveAllKeys( );
006 void setAny(in string key, in any value)
007 raises (NoWorkArea, NotOriginator, PropertyReadOnly);
008 void setAnyByMode(in string key,
009 in any value,
010 in PropertyModeType mode)
011 raises (NoWorkArea, NotOriginator, NotInScope, PropertyReadOnly);
012 any getAny(in string key);
013 PropertyModeType getMode(in string key);
014 void removeAny(in string key)
015 raises (NoWorkArea, NotOriginator, PropertyFixed);
016 WorkAreaToken suspend( );
017 void resume(in WorkAreaToken token)
018 raises (InvalidToken, InvalidParentContext);
019 ExportedWorkArea exportWorkArea( ) raises (NoWorkArea);
020 void importWorkArea(in ExportedWorkArea token)
021 raises (InvalidParentContext);

Although Table 3 illustrates the use of the setany, getany, and other various methods, other embodiments may comprise a plurality of methods to manipulate properties in a work-area. A first method, referred to herein as the “begin” method (example at line 002), creates a new work-area and associates it with the current thread. If the current thread is already associated with a work-area, the newly created work-area will be nested within the already associated work-area. Otherwise, the work-area exists as the root of a possible stack of work-areas. The name passed in may not be null or else a CORBA::BAD_PARAM exception is thrown.

A second method referred herein as the “complete” method (example at line 003) causes the work-area associated with the current thread to complete. If the work-area is nested within a parent, then that parent work-area becomes associated with the thread. If there is no work-area associated with the current thread, the “NoWorkArea” exception is raised. The “complete” method may only be called from within the process in which the work-area is rooted. If a call to complete the work-area is made from a process into which the work-area was imported, the “NotOriginator” exception is raised.

A third method, herein referred to as the “suspend” method (example at line 016), suspends the work-area associated with the current thread and any parent contexts as well, up to the root, guaranteeing that no work-area will be associated with the current thread at the completion of the method. Null is returned if there is no associated work-area with the thread.

A fourth method, herein referred to as the “resume” method (example at lines 017 to 018), resumes the work-area represented by “token” of the type “WorkAreaToken”. There must be no work-area already active on the thread. If the token is null then no new association is made on the thread. If the token does not represent a valid set of contexts then the “InvalidToken” exception is raised and no new association is made on the thread. If any work-area is active on the thread when resume is called, then the “InvalidParentContext” exception is raised and no new association is made on the thread.

A fifth method, herein referred to as the “exportWorkArea” method (example at line 019), provides a method by which the state of an entire stack of work areas associated with a thread is copied into a data structure that can be passed without change across process boundaries and even stored external to the process, e.g. on a local file system. The “ExportedWorkArea” type represents such a format; for example, a binary sequence of bytes. This method allows one thread's context to be copied to another, for example, or passed across asynchronous transport mechanisms like distributed messaging embodiments.

A sixth method, herein referred to as the “importWorkArea” method (example at lines 020 to 021), recreates a previously exported work-area context structure on the current thread. If there is already an active work-area on the thread, the “InvalidParentContext” exception is raised.

A seventh method, herein referred to as the “getName” method (example at line 004), returns the name that was associated with the work-area created by the begin method, or returns null if no work-area is associated with the current thread.

An eighth method, herein referred to as the “retrieveAllKeys” method (example at line 005), returns an array holding a copy of (or immutable references to) all keys viewable from the current work-area. If the work-areas are nested, this will return the full set of keys without duplicates.

A ninth method, herein referred to as the “setany” method (example at lines 006 to 007), sets the property value of the given key into the current scope of context. The mode will default to normal. The “PropertyReadOnly” exception will be raised if the property has already been set in the current or an enclosing scope with a read_only or fixed_readonly mode. If the policy of the embodiment is to disallow changes from the server to be returned to the client, then the “NotOriginator” exception will be raised if the current work area was imported from the client. Neither the key nor the value may be null; the value must be a valid and marshallable instance; otherwise, a BAD_PARAM exception will be raised. If there is no active work area on the thread, then the “NoWorkArea” exception is raised and context is not set.

A tenth method, herein referred to as the “setAnyByMode” method (example at lines 008 to 011), raises the NoWorkArea, NotOriginator and PropertyReadOnly exceptions under the associated conditions. This is accomplished in the same manner as in the setany method above, but associates the property with the provided mode input parameter (of the type “PropertyModeType”). If the mode is null, a BAD_PARAM exception is raised.

An eleventh method, referred herein as the “getany” method (example at line012), returns the value mapped to the given key in the most nested context in which the key/value pair is accessible.

A twelfth method, herein referred to as the “getMode” method (example at line 013), returns the mode associated with the property indicated by the input parameter “key”. In a particular embodiment, it is advantageous that, if no such property exists at any level of nesting on the current thread, then PropertyModeType::normal is returned, without suggesting that a property with the given key necessarily actually exists.

A thirteenth method, herein referred to as the “removeAny” method (example at lines 014 to 015), can raise the NoWorkArea, NotOriginator, and PropertyFixed exceptions, and removes the value associated with the given key from the scope of the current work area. If the value does not exist, no action is taken. Parent contexts are never affected by this method. If there is no active work area on the thread, the “NoWorkArea” exception is raised. If the value exists in an enclosing scope, then the value will be removed until the current work area from which the removeAny method was issued is completed. If the work area was imported from a client and a particular embodiment disallows changes to an imported work area, then the NotOriginator exception is raised. If the property was set as fixed_normal or fixed_readonly, then the “PropertyFixed” exception is raised.

### 7.0 Creating a Work-Area

The client creates a work-area and inserts a site-identifier property into the work-area. This requires four steps on the part of client: Binding to the work-area. Creating a work-area. Inserting information into the work area. Terminating the work area when it is no longer needed. These four steps are discussed below:

### 7.1 Binding to the Work-Area

The work-area provides an implementation of the Current interface shown in Table 3. This implementation is registered with the ORB during initialization. Applications get a reference to the current implementation by passing the string WorkAreaCurrent to the ORB's resolve_initial_references method known in the art.

### 7.2 Beginning a Work-Area

After a client has a reference to the Current interface show in Table 3, it can use the begin method to create a new work area and associate it with the calling thread. The begin method takes a string as an argument. The string is used to name the work area. A null string must not be passed otherwise, the CORBA::BAD_PARAM exception is thrown. Each work area must also be terminated within the process that created it. Each call to the begin method must have a corresponding call to the complete method. “Completing a work area” is discussed further below. The begin method is also used to create nested work areas. If a work area is associated with a thread when the begin method is called, the method creates a new work area nested within the existing work area. Starting and ending a nested work area is discussed below. The work-area facility makes no use of the names associated with work area. Programmers can name work areas in any way they choose. Names are not required to be unique, but the usefulness of the names for debugging is enhanced if the names are distinct and meaningful within the application. Applications can use the getName method to return the name associated with a work area by the begin method.

### 7.3 Manipulating Properties in a Work-Area

As an illustration, an application with a current work-area can insert properties into the work-area and retrieve the properties from the work-area. The Current interface shown in Table 3, provides the setany, setAnyByMode, and getany methods to set and retrieve properties. The setany method inserts the property with the property mode of normal. The setAnyByMode argument can be used to insert a property with a different property mode. The setany method takes the key and the value as arguments. The key is a string and the value is an object of the CORBA type Any. The ORB provides a create_any method for creating Any objects. Applications can use any appropriate technique to insert property values into the Any object. The Any class provides a set of methods like insert_string and extract_string for manipulating Any objects. Applications use the getany method to retrieve a property from a work area. The getany method takes the key as an argument and returns a CORBA Any object that encapsulates the value associated with the key. The property value can be extracted from the Any object by any appropriate technique. The extraction methods on the Any class can be used to retrieve the value from the returned object, or applications can provide their own methods. For example, to retrieve the value of the siteID key from the work-area, the getany method is used to retrieve the Any object and the LocationHelper.extract method is used to return the value. The LocationHelper class is generated from the CORBA IDL. This method is also used by the server to extract the property from the work area. Although Table 3 illustrates the use of the setany and getany methods, other embodiments may comprise a plurality of methods to manipulate properties in a work-area.

As an illustration of methods to manipulate properties in a work-area, a first method herein referred to as the querying the name of a work area method, returns null if there is no work area associated with the thread. This is the recommended technique for determining whether there is an active work area associated with the thread.

A second method, herein referred to as the querying a list of all keys method, takes no arguments and returns an array of strings. This method returns null if there is no work area associated with the thread. If there is associated work area containing no properties, the method returns an array of size 0.

A third method, herein referred to as the querying the mode of a property method, takes the property's key as an argument and returns the mode as a PropertyModeType object. If the specified key does not exist in the work area, the method returns PropertyModeType.normal indicating that the property can be set and removed without error.

A fourth method, herein referred to as the deleting a property method, takes the property's key as an argument. Only properties with the modes normal and read-only can be removed, or deleted. Attempting to remove properties set within previously created work areas causes the NotInScope exception to be thrown. Attempting to remove properties in work-areas that originated in other processes causes the NotOriginator exception to be thrown.

A fifth method, herein referred to as the setting properties with modes other than normal method, allows the setting of a properties as fixed-normal, read-only, and fixed read-only. This method can also be used to modify the mode of an existing property when the mode of the property allows for it.

### 7.4 Completing a Work-Area

After an application finishes using the work-area, it must terminate the work-area. This terminates the association with the calling thread and destroys the work-area. If the complete method is called on a nested work-area, the nested work-area is terminated and the parent work-area becomes the current work-area. If there is no work-area associated with the calling thread, the NoWorkArea exception is thrown.

Every work-area must be terminated, and work-areas can be terminated only by the originating process. For example, if a server attempts to call the complete method on a work-area that originated in a client, the NotOriginator exception is thrown.

### 8.0 Using a Work-Area

The server side accepts remote invocations from clients. With each remote call, the server also gets a work area from the client if the client has created one. The work area is propagated transparently. None of the remote methods includes the work area on its argument list. In the example application in Table 1, the server extracts the site identifier from the work area and uses it to guide the local work. Extracting the site identifier requires two steps on the part of the server application. Those steps are binding to the work-area facility and extracting information from the work area. These steps are discussed in more detail below.

### 8.1 Binding to the Work-Area Facility

To access the work-area facility, the server obtains a reference to the Current implementation by passing the string WorkAreaCurrent to the ORB's resolve_initial_references method. This reference must then be narrowed by passing it to the narrow method on the com.ibm.IWorkArea.CurrentHelper class. The technique used by the server to access the work-area is identical to the technique used by the client discussed above.

### 8.2 Extracting Properties from a Work-Area

Properties are inserted into the work area by using the setany and setAnyByMode methods on the Current interface. In both cases, the value associated with the key is encapsulated into a CORBA Any object. To extract properties from a work area, applications use the getany method to retrieve the property value encapsulated in an Any object. The property value can be extracted from the Any object by any appropriate technique. The extraction methods on the Any class can be used to retrieve the value from the returned object, or applications can provide their own methods. For example, to retrieve the value of the site identifier from the work area, the getany method on the work-area is used to retrieve the Any object and the LocationHelper.extract method is used to return the value.

### 8.3 Modifying Information in a Work-Area

If the client creates a work area, the work area is sent with each remote call to the server. If the server accepts an invocation from a client and does nothing to the values in the work area before making invocations to other servers, the unmodified work area is propagated with these invocations. However, the server accepting the original client's invocation can, in keeping with the property mode restrictions, mask values set in the work area by the client. If the server then makes invocations to other servers, the modified work area is propagated. The server does work without modifying the received work area. Any remote invocations made during this work propagates the unmodified work area. The server then creates a new work area, nested within the received work area, and sets a new site-identifier value within the new work area. The server then does additional work. Any remote invocations made during this work propagate the modified work area.

Finally, the server terminates the nested work area, destroying any local modifications to the originally received work area. Any further remote invocations propagate the unmodified work area. The server must terminate the nested work area before the remote invocation returns to the client; the work area must be completed in the process that began it.

### 8.4 Manipulating work areas

If an application has a work area associated with a thread and issues an invocation from that thread, the work area is made available to the target of the invocation. The work-area facility provides a mechanism for suspending work on a thread and later resuming it, on the same thread or on a different thread, in the same process. Applications can use this mechanism to temporarily disassociate a work area from a thread. For example, a server that receives a work area from a client can suspend the work area to prevent it from being propagated with remote calls made by the server. To suspend a work area, an application calls the suspend method on the Current interface. If the suspend method is called from a nested work area, all work areas in the hierarchy are suspended, including the root work area. No work area is associated with the calling thread when the suspend method returns. This method returns a token (WorkAreaToken), which captures all the information about the work area, including the nesting structure. The token is valid only within the process in which it was created. It cannot be passed to another process. To re-associate the work-area with a thread, the application calls the resume method, passing the token as an argument. The resume method can be called only once on a given token. Additional attempts result in the exception InvalidToken being thrown.

While the foregoing is directed to embodiments of the present invention, other and further embodiments of the invention may be devised without departing from the basic scope thereof, and the scope thereof is determined by the claims that follow.

What is claimed is:

1. A method of defining a work-area for propagating context in a distributed computer environment, comprising:
binding to a work-area interface;
creating the work-area configured to contain an end-user definable context;
inserting the end-user defined context into the work-area; and
associating the work area with a request.

2. The method of claim 1, wherein binding comprises initializing the work-area interface.

3. The method of claim 1, further comprising:
sending the work area with the request to at least one remote machine in the distributed computer environment.

4. The method of claim 3, wherein associating comprises associating the work-area with a calling thread.

5. The method of claim 3, wherein inserting the end-user defined context is performed by operation of an input device under the control of an end-user.

6. The method of claim 1, further comprising:
receiving a remotely defined work-area from a remote computer in the distributed computer environment; and
nesting the work-area into the remotely defined work-area.

7. The method of claim 6, wherein information of the nested work-area masks corresponding information contained in the remotely defined work-area and each successive nested work-area.

8. The method of claim 1, wherein creating the work-area comprises scoping the work-area to be insensitive to process boundaries of processes executing on remotes machines of the distributed computer environment.

9. The method of claim 1, wherein creating is preformed by an originating process and wherein the work-area is configured for termination only by the originating process.

10. A computer system in a distributed environment, comprising:
a network interface configured to support a network connection with at least one remote computer in the distributed environment;
a memory containing a work area program comprising a work-area interface;
at least one processor which, when executing a work-area program, is configured to perform an operation comprising:
binding to the work-area interface; and
creating the work-area configured to contain an end-user definable context.

11. The computer system of claim 9, wherein the operation performed by the at least one processor further comprises:
inserting an end-user defined context into the work-area;
associating the work area with a request; and
sending the work area with the request.

12. The computer system of claim 11, further comprising an input device under the control of an end-user and configured for inserting the end-user defined context into the work-area.

13. The computer system of claim 10, wherein the operation performed by the at least one processor further comprises:
receiving a remotely defined work-area; and
nesting the work area into the remotely defined work-area.

14. A computer readable medium containing a program which, when executed performs an operation for defining a work-area for propagating context in a distributed computer environment, the operation comprising:
binding to a work-area interface; and
creating the work-area configured to contain an end-user definable context.

15. The computer readable medium of claim 14, wherein binding comprises initializing the work-area interface.

16. The computer readable medium of claim 14, further comprising:
inserting an end-user defined context into the work-area;
associating the work area with a request; and
sending the work area with the request to at least one remote machine in the distributed computer environment.

17. The computer readable medium of claim 16, wherein associating comprises associating the work-area with a calling thread.

18. The computer readable medium of claim 16, wherein inserting the end-user defined context comprises inputting end-user information into the work-area by operation of an input device under the control of an end-user.

19. The computer readable medium of claim 14, further comprising:
receiving a remotely defined work-area from a remote computer in the distributed computer environment; and
nesting the work area into the remotely defined work-area.

20. The computer readable medium of claim 19, wherein information of each nested work-area masks corresponding information contained in each successive nested work-area.

21. The computer readable medium of claim 14, wherein creating the work-area comprises scoping the work-area to be insensitive to process boundaries of processes executing on remotes machines of the distributed computer environment.
